(19) United States
(12) Patent Application Publication
(10) Pub. No.: US 2011/0202359 A1
(43) Pub. Date: Aug. 18, 2011

(54) System and method for determining a nutritional value of a food item

(76) Inventor: Stanley C. Rak, Whitehouse Station, NJ (US)

(21) Appl. No.: 12/658,820

(22) Filed: Feb. 16, 2010

(51) Int. Cl. G06Q 99/00; G06Q 50/00

(52) U.S. Cl. 705/1.1

(57) ABSTRACT

Computer-implemented method, system, and computer program product for determining a nutritional health value of a food item are disclosed. The method includes receiving information about number of ingredients, controversial ingredients, nutrients and vitamins contained in the food item, assigning a predetermined weighting value to each nutrient contained in the food item. For each nutrient contained in the food item, the method determines a nutrient value based on a percentage of the nutrient contained in the food item and the weighting value of each nutrient contained in the food item. For each vitamin contained in the food item, the method determines a vitamin value based on a sum of percentages of all vitamins contained in the food item. The method further determining an ingredient value based on a total number of ingredients and a total number of controversial ingredients contained in the food item. Then, the method calculates a negative-health-effect value based on a sum of a first set of nutrient values, a positive-health-effect value based on a sum of a second set of nutrient values, a nutrient-to-vitamin value using the calculated negative-health-effect value, the calculated positive-effect-value, and a maximum weight of the calculated positive-effect-value, and a controversial ingredient penalty value. The nutritional health value of the food item is generated using the calculated nutrient-to-vitamin value and the calculated controversial ingredient penalty value.

### BACKGROUND OF THE INVENTION

1. Field of the Invention

In general, the present invention relates to systems and methods for ascertaining a nutritional value of a food item. Specifically, the present invention relates determination of a nutritional score or value of a food item based on various constituents and their corresponding percentages or weightings in the food item.

2. Background

In today's world of a vast variety of nutritional choices, proper diet plays an important role in maintaining individual's health. Specifically, beneficial dietary choices may reduce development of chronic diseases, weight gain, or other negative effects on a person while improving longevity and overall quality of life. Whereas, poor dietary choices typically have a counter-effect on an individual. The overall diet is determined by a series of individual selections, and thus, proper identification of high or better quality nutritional items is a prerequisite for a healthy diet.

Many food items currently sold in the United States are required to have a “Nutrition Facts” panel as mandated by the Nutrition Labeling and Education Act (“NLEA”) and Food and Drug Administration (“FDA”). These panels sometimes provide basic nutritional information and may categorize foods into a “food group” or “food groups.” However, such categorization can be imprecise, somewhat misleading or difficult to understand. Additional factors, including serving sizes, mixing with other non-nutritious components (e.g., water), may make it even more difficult to understand the actual nutritional value of a food item being consumed.

Some conventional nutritional methods relate to selection of individual items of food for specific nutritive values, and scoring the aggregate nutritive values of a series of food articles selected for an individual serving of a meal in order to provide an improved form of food-selecting-chart. These methods may generate a sheet on which articles of food are listed in relation to measurements of quantities of their nutrient ingredients in terms of a common rating factor. A common unit measure may be derived by dividing the established measure of the daily requirement per person of each of these items by three, the number of daily meals, and then dividing such quotients by some common arbitrary figure that is selected as representing the number of desired stages in a scoring scale. This provides a fractional scoring unit that is common to individual score scales for the various nutrients that are to be taken into account.

Other conventional methods include enabling individuals to select proper foods for improving health, controlling hunger and managing body weight based on calculations derived from a food's measured nutritional content. These methods involve assigning a ranking to food based on a combination of its calculated nutrient density and a predicted satiating effect. The nutrient density represents a selectively weighted overall nutrient density of the food and is calculated by a formula that yields a numerical rating or scale that proportionately rewards foods that have the highest amount of nutrients per calorie for nutrients that the FDA deems essential. The satiating effect predicts the satiation of a food on a numeric scale. A high effect value indicates that the food will be more satisfying per calorie. The two calculating factors or indices may then be represented and interpreted in an easy to use manner such as on a visual format.

Yet another conventional method involves an iterative algorithm for building a nutritionally balanced list of foods. The algorithm has the following steps: (a) creating an array of values indicating the level of deficiency/surplus in the current food list when compared to a selected standard; (b) comparing each food in a list of favorites to the deficiency/surplus profile, and generating a score for each food indicating the level of match; (c) using the scores to guide a user or algorithm in selecting a food to add to the list; and (d) repeating the above steps until the desired level of compliance is reached.

Other conventional methods also involve rating the nutritional quality of food. These methods include: (a) determining the water free weight percentage of one or more macronutrients in the food item; (b) assigning a numerical influence factor to each of the macronutrients; (c) multiplying the water free weight percentage of each macronutrient by the influence factor of the macronutrient to calculate a nutrient and influence factor product for each macronutrient; and (d) summing the nutrient and influence factor products of the macronutrients to calculate a numerical rating for the food item.

However, the conventional methods do not appear to take into account various assumptions, nutrient weightings, as well as, nutrient, vitamin and ingredient scores that are calculated based on the constituents of a particular food item. Thus, there is a need for a system and method for determining a nutritional health value or score of a food item that uses various inputs, including assumptions based on recommended daily intake (“RDI”) value(s) as well as nutrient weightings, to calculate a set of scores relating to nutrients, vitamins and ingredients in a particular food item, where such scores along with other variables are used in several formulas to determine the health score of the food item.

### SUMMARY OF THE INVENTION

In some embodiments, the present invention relates to a computer-implemented method for determining a nutritional health value of a food item. The method includes receiving information about number of ingredients, controversial ingredients, nutrients and vitamins contained in the food item; assigning a predetermined weighting value to each nutrient contained in the food item; for each nutrient contained in the food item, determining a nutrient value based on a percentage of the nutrient contained in the food item and the weighting value of each nutrient contained in the food item; for each vitamin contained in the food item, determining a vitamin value based on a sum of percentages of all vitamins contained in the food item; determining an ingredient value based on a total number of ingredients and a total number of controversial ingredients contained in the food item; calculating a negative-health-effect value based on a sum of a first set of nutrient values, wherein the first set of nutrient values is configured to have a negative health effect on the quality of the food item; calculating a positive-health-effect value based on a sum of a second set of nutrient values, wherein the second set of nutrient values is configured to have a positive health effect on the quality of the food item; calculating a nutrient-to-vitamin value using the calculated negative-health-effect value, the calculated positive-effect-value, and a maximum weight of the calculated positive-effect-value; calculating a controversial ingredient penalty value; generating a nutritional health value of the food item using the calculated nutrient-to-vitamin value and the calculated controversial ingredient penalty value.

In some embodiments, the present invention relates to a computer-implemented system for determining a nutritional health value of a food item. The system includes a memory and a processor. The processor is configured to receive information about number of ingredients, controversial ingredients, nutrients and vitamins contained in the food item; assign a predetermined weighting value to each nutrient contained in the food item; for each nutrient contained in the food item, determine a nutrient value based on a percentage of the nutrient contained in the food item and the weighting value of each nutrient contained in the food item; for each vitamin contained in the food item, determine a vitamin value based on a sum of percentages of all vitamins contained in the food item; determine an ingredient value based on a total number of ingredients and a total number of controversial ingredients contained in the food item; calculate (1) an negative-health-effect value based on a sum of a first set of nutrient values, wherein the first set of nutrient values is configured to have a negative health effect on the quality of the food item; (2) a positive-health-effect value based on a sum of a second set of nutrient values, wherein the second set of nutrient values is configured to have a positive health effect on the quality of the food item; (3) a nutrient-to-vitamin value using the calculated negative-health-effect value, the calculated positive-effect-value, and a maximum weight of the calculated positive-effect-value; (4) a controversial ingredient penalty value. Then the processor outputs a nutritional health value of the food item using the calculated nutrient-to-vitamin value and the calculated controversial ingredient penalty value.

In some embodiments, the present invention relates to a computer program product stored on a computer-readable medium, for use with a computer configured to determine a nutritional health value of a food item, the computer program product comprising computer-readable instructions for causing the computer to; receive information about number of ingredients, controversial ingredients, nutrients and vitamins contained in the food item; assign a predetermined weighting value to each nutrient contained in the food item; for each nutrient contained in the food item, determine a nutrient value based on a percentage of the nutrient contained in the food item and the weighting value of each nutrient contained in the food item; for each vitamin contained in the food item, determine a vitamin value based on a sum of percentages of all vitamins contained in the food item; determine an ingredient value based on a total number of ingredients and a total number of controversial ingredients contained in the food item; calculate (1) a negative-health-effect value based on a sum of a first set of nutrient values, wherein the first set of nutrient values is configured to have a negative health effect on the quality of the food item; (2) a positive-health-effect value based on a sum of a second set of nutrient values, wherein the second set of nutrient values is configured to have a positive health effect on the quality of the food item; (3) a nutrient-to-vitamin value using the calculated negative-health-effect value, the calculated positive-effect-value, and a maximum weight of the calculated positive-effect-value; (4) a controversial ingredient penalty value. Then, a nutritional health value of the food item is generated using the calculated nutrient-to-vitamin value and the calculated controversial ingredient penalty value.

Further features and advantages of the invention, as well as structure and operation of various embodiments of the invention, are disclosed in detail below with references to the accompanying drawings.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 is illustrates an exemplary system for determining a nutritional value of a food item, according to some embodiments of the present invention.

FIG. 2 flow chart of an exemplary method for determining a nutritional value of a food item, according to some embodiments of the present invention.

FIG. 3 illustrates an exemplary food pyramid.

### DETAILED DESCRIPTION OF THE INVENTION

In some embodiments, the present invention relates to systems, methods, and computer-readable medium for determining or otherwise ascertaining a nutritional health value or score of a selected food item or items.

In some embodiments, the present invention relates to a method for determining a health score of a particular food item. In some embodiments, the method uses various dietary guidelines as proposed by Food and Drug Administration (“FDA”). In some embodiments, these dietary guidelines are based on an assumption that an average individual will consume approximately 2000 calories per day when all his/her daily meals' nutritious values are combined together. Pursuant to the Federal Food, Drug, and Cosmetic Act (“the Act”) and accompanying legislation, the FDA has authority to oversee the quality of substances sold as food in the United States, and to monitor claims made in the labeling about both the composition and the health benefits of foods. Substances which the FDA regulates as food are subdivided into various categories, including foods, food additives, added substances (man-made substances which are not intentionally introduced into food, but nevertheless end up in it), and dietary supplements. The specific standards which the FDA exercises differ from one category to the next. Further, the FDA has been granted a variety of means by which it can address violations of the standards for a given category of substances. The Act defines “food” to be: (1) articles used for food or drink for man or other animals, (2) chewing gum, and (3) articles used for components of any such article.

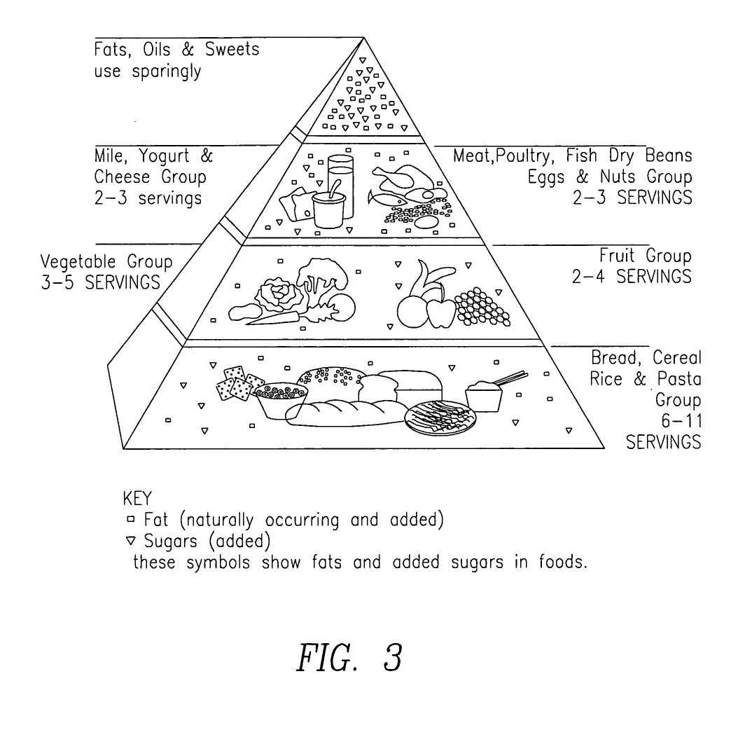

United States Department of Agriculture (“USDA”) also provides additional nutrition recommendations in the form of a food guide pyramid. The food guide pyramid suggests optimal nutrition guidelines for each food category, per day, using a mnemonic graphic of a pyramid with horizontal dividing lines to represent suggested percentages of the daily diet for each food group. The pyramid is currently published every five years. An update to the 2005 system is expected in 2010. An exemplary pyramid is shown in FIG. 3.

Carbohydrates are represented by cereals, bread, pastas, crackers, and rice. Bread, cereal, rice, and pasta are grown from cereal crops. Grains supply food energy in the form of starch and carbohydrates. Breads made from refined ingredients are not as highly recommended as whole grains. Whole grains can be found especially in brown oatmeal. USDA recommends 6-11 servings daily of carbohydrates.

A vegetable is a part of a plant consumed by humans that is generally savory (not sweet) and not considered a grain, fruit, nut, spice, or herb. For example, the stem, root, flower, etc., may be eaten as vegetables. Vegetables contain many vitamins and minerals; however, different vegetables contain different spreads, so it is important to eat a wide variety of types. For example, green vegetables typically contain vitamin A, dark orange and dark green vegetables contain vitamin C, and vegetables like broccoli and related plants contain iron and calcium. Vegetables are very low in fats and calories, but cooking can often add these. USDA recommends 3-5 servings of vegetables in a day. They may be fresh, frozen, canned, or juiced.

In terms of food (rather than botany), fruits are the sweet-tasting seed-bearing parts of plants, or occasionally sweet parts of plants which do not bear seeds. These include apples, oranges, plums, bananas, etc. Fruits are low in calories and fat and are a source of natural sugars, fiber and vitamins. Processing fruits when canning or making into juices unfortunately may add sugars and remove nutrients. The fruit food group is sometimes combined with the vegetable food group. Note that many foods considered fruits in botany because they bear seeds are not considered fruits in cuisine because they lack the characteristic sweet taste, e.g., tomatoes or avocados. It is best to consume 2-4 servings of fruit in a day. They may be fresh, frozen, canned, dried, pureed or juiced.

Dairy products are produced from the milk of mammals, most usually but not exclusively cattle. They include milk, yogurt and cheese. Milk and its derivative products are a rich source of the mineral calcium, but also provide protein, phosphorus, vitamin A, and vitamin D. However, many dairy products are high in saturated fat and cholesterol compared to vegetables, fruits and whole grains, which is why skimmed products are available as an alternative. For adults, USDA recommends 3 cups of dairy products per day.

Meat is a major source of protein, as well as iron, zinc, and vitamin B12. Meats, poultry, and fish include beef, chicken, pork, salmon, tuna, and shrimp, eggs, spices and herbs are also in this group. However, since many of the same nutrients found in meat can also be found in foods like eggs, dry beans, and nuts, such foods are typically placed in the same category as meats, as meat alternatives. These include tofu, products that resemble meat or fish but are made with soy, eggs, and cheeses. The meat group is one of the major compacted food groups in the food guide pyramid. Although meats provide energy and nutrients, they are often high in fat and cholesterol, and can be high in sodium. Simply trimming off fatty tissue can go a long way towards reducing this negative effect. However, this tactic may prove to be ineffective, so large portions of meats are not recommended; 2-3 ounces per day of meat or alternatives are recommended. This is 3-5 servings. For those who don't consume meat or animal products (see Vegetarianism and Taboo food and drink), meat analogues, tofu, beans, lentils, chick peas, nuts and other high-in-protein vegetables make up this group.

Based on the above food groups, the FDA recommends that a healthy individual's daily diet should consist of approximately 2000 calories. This diet should include the following constituents, as illustrated in TABLE 1, which can be spread amongst multiple food groups illustrated in FIG. 3.

TABLE 1
Recommended Daily Intake Values.

| | Approximate Weight/ | |
|---|---|---|
| Constituent | Recommended Daily Intake (in grams) | |
| Saturated Fat | 20 | g |
| Trans Fat | No more than 1% of daily caloric intake | |
| Cholesterol | 300 | mg |
| Sodium | 2400 | mg |
| Sugar | No more than 8% of daily caloric intake | |
| Protein | 60 | g |
| Dietary Fiber | 25 | g |
| Potassium | 3500 | mg |

Recommended Daily Intake (“RDI”) is based on the daily dietary intake level of a nutrient which was considered (at the time they were defined) to be sufficient to meet the requirements of nearly all (97-98%) healthy individuals in each life-stage and sex group. The RDI is used to determine the Daily Value which is printed on food labels in the United States, Canada, and Australia.

Additionally, it is recommended that a healthy individual consume certain amount of vitamins and minerals, which are also calculated based on a specific RDI value, as shown in TABLE 2 below.

TABLE 2
Recommended Daily Intake Values for Vitamins/Minerals.

| | | | Highest Recommended Dietary | |
|---|---|---|---|---|
| | Recommended | | Allowance of Dietary | |
| Vitamin/Mineral | Daily Intake | | Reference Intake | |
| Vitamin A | 3000 | IU | 10,000 | IU |
| Vitamin C | 60 | mg | 90 | mg |
| Calcium | 1000 | mg | 1300 | mg |
| Iron | 18 | mg | 18 | mg |
| Vitamin D | 400 | IU | 600 | IU |
| Vitamin E | 30 | IU | 15 mg (33 IU of synthetic) | |
| Vitamin K | 80 | μg | 120 | μg |
| Thiamin | 1.5 | mg | 1.2 | mg |
| Riboflavin | 1.7 | mg | 1.3 | mg |
| Niacin | 20 | mg | 16 | mg |
| Vitamin B6 | 2 | mg | 1.7 | mg |
| Folate | 400 | μg | 400 | μg |
| Vitamin B12 | 6 | μg | 2.4 | μg |
| Biotin | 300 | μg | 30 | μg |
| Pantothenic acid | 10 | mg | 5 | mg |
| Phosphorus | 1000 | mg | 1250 | mg |
| Iodine | 150 | μg | 150 | μg |
| Magnesium | 400 | mg | 420 | mg |
| Zinc | 15 | mg | 11 | mg |
| Selenium | 70 | μg | 55 | μg |
| Copper | 2 | mg | 900 | μg |
| Manganese | 2 | mg | 2.3 | mg |
| Chromium | 120 | μg | 35 | μg |
| Molybdenum | 75 | μg | 45 | μg |
| Chloride | 3400 | mg | 2300 | mg |

As can be understood by one skilled in the art, the present invention's method is not limited to the listed constituents and vitamins/minerals in TABLE 1 and TABLE 2, respectively. As such, other constituents may be present in individual's diet and appropriate RDI values can be assigned to them. However, for ease of description, the present invention will be discussed in connection with the RDI values shown in TABLE 1.

In some embodiments, in order to determine a health score of a particular food item, each one of the constituents or nutrients are assigned a particular point value, as shown in TABLE 3 below.

TABLE 3
Point Values or Weightings for Each Nutrient.

| | | |
|---|---|---|
| Nutrient | RDI (in grams) | Weightings (w) |

| Saturated Fat | 20 | g | 20 |
|---|---|---|---|
| Trans Fat | No more than 1% of daily | | 20 |
| | caloric intake | | |
| Cholesterol | 300 | mg | 20 |
| Sodium | 2400 | mg | 5 |
| Sugar | No more than 8% of daily | | 10 |
| | caloric intake | | |
| Protein | 60 | g | 17 |
| Dietary Fiber | 25 | g | 16 |
| Potassium | 3500 | mg | 7 |

In some embodiments, each of the point values listed in TABLE 3 can be empirically determined, whereby a higher point value is assigned to a constituent/nutrient based on how it affects eventual calculation of a health score of a food item. As can be understood by one skilled in the art, the above point values are provided here for illustrative purposes only and are not meant to be limiting the scope of the present invention. As can be further understood by one skilled in the art, any point values are possible. Further, such values can be determined in any number of ways, e.g., experimentally, predetermined by the user, a separate expert, a nutrition consultant, or in any other way. Additionally, the total value of all weightings may be predetermined for a particular food item, group of food items, or otherwise depend on a particular calculation of the food score value discussed below. In some embodiments, the sum of all weightings can be greater or less than 100 (as the health score value of a food item can be rounded to a value between 0 and 100). In some embodiments, the values totaling greater than 100 allow for some padding on each end of the health score of the food item which makes up for some older product data that was entered before certain nutritional values were required (for example, values trans fat were excluded in such older product data).

Using these point values, a score or a factor for each of these nutrients/constituents is determined based on the following relationship:

Nutrient score=((p/r)[0,δ])*w (1)
where p is a percent of the nutrient in a product; r is the percent RDI of the nutrient; w is the nutrient's weighting; [0,δ] indicates that the value of (p/r) is greater than or equal to 0 and less than or equal to δ, where δ is a predetermined value. If (p/r) is greater than δ, then its value is rounded to δ. In some embodiments, δ can be equal to 1.

For example, if a food item or product contains 300 calories and includes 5 grams of saturated fat, then percent of saturated fat in this product (p) is equal to 15%. Percent RDI (r) of the saturated fat is 25%, thus, (p/r) is equal to 0.6. Since nutrient weighting is 20 pts, then nutrient score is equal to 12.

Since the food items contain vitamins and/or minerals, the vitamin scores are also calculated using the following equation:

Vitamin score=SUM(v)*xᵥ (2)
where v is a percent of the vitamin in a product; SUM indicates a sum of all vitamins/minerals in a product. Further, in some embodiments, all of the vitamins/minerals are assigned an equal weighting value of xᵥ. In some embodiments, xᵥ=10. In some embodiments, each vitamin can be assigned a different value of xᵥ.

The next step in determining the health score or a health value of a food item is a calculation of a total number of ingredients in the food item. For a particular food item, the number of ingredients can be obtained from a database. This database can contain a listing of various food items and include information about nutrients, vitamins, ingredients, and any other pertinent information that are contained within the food item. The total number of ingredients is added up, which is equal to a total number of ingredients (a). The total number includes all ingredients whether or not positively or negatively affecting the health value of the food item.

Then, a number of controversial ingredients (c) is calculated. A controversial ingredient is an ingredient that can negatively affect the health value of a food item. In some embodiments, such ingredient can naturally occur in the food item or can come from a supplement or component that is added to the food item, for example a dye, a chemical additive, or any other substance that might not be naturally occurring in the food item. As stated above, the present invention can be configured to use a database that contains information about numbers of ingredients, number of controversial ingredients, what the ingredients are and their composition as well as percent weight for each particular food item being evaluated. This database can be continuously updated with information about new or existing food items.

Based on the total number of ingredients and number of controversial ingredients, an ingredient score is calculated as follows:

Ingredient score=c/a (3)
as stated above, “c” is the number of controversial ingredients and “a” is the total number of ingredients in a food item, as obtained from a database.

In some embodiments, any ingredients that are hydrogenated (e.g., hydrogenated fat) can be configured to be counted once for (a) and three times for (c). This means that if the only ingredient is hydrogenated fat, then the ingredient score is 3. If the ingredients of a particular food item are not known or are not disclosed, a penalty can be assessed to the final ingredient score. This means that the ingredient score calculated by equation (3) is reduced or is a percentage of an ingredient score that could have been obtained if the ingredients were known. In some embodiments, such penalty can be in a range of 25% to 75% reduction of the calculated ingredient score. In a preferred embodiment, the penalty is 50% reduction of the ingredient score.

Now, that the values of nutrient score, vitamin score, and ingredient score are calculated, the values or scores for a combination of constituents or nutrients can be determined. Specifically, a combined score for all nutrients that are negatively affecting the health value of a food item is calculated. Such “negative” nutrients include, but not limited to, saturated fat, trans fat, cholesterol, sodium, sugar, and any others. Such “negative” nutrients can negatively affect the quality of the food item and/or may have an adverse effect on user's health after consuming the food item. The nutrient scores for each of these nutrients are determined using equation (1) above. Once the scores for each such nutrient are determined, the scores are added and the combined score that negatively affects the health value of a food item (a “bad” score) is calculated as follows:

“Bad” score=(saturated fat nutrient score+trans fat nutrient score+cholesterol nutrient score+sodium nutrient score+sugar nutrient score)/100 [0, α] (4)
where the calculated value of the “bad” score cannot be greater than a or less than 0, where α is a predetermined value that can be set in any number of ways discussed above with regard to weighting values. If it greater than α, then the value is rounded to α. In some embodiments, α can be equal to 0.7. In some embodiments, α can be equal to 1.

Then, a combined score for nutrients and/or vitamins that have a positive effect on a food item, i.e., improve its quality and hence have a positive effect on user's health after consuming the food item (“good” score), for nutrients such as protein, dietary fiber, potassium, and vitamin is calculated in a similar fashion, as illustrated by the equation (5) below. The nutrient scores listed in equation (5) are obtained using equation (1) and the vitamin score is obtained using equation (2) above.

“Good” score=(protein nutrient score+dietary fiber nutrient score+potassium nutrient score+vitamin score)/100 [0,β] (5)

where the calculated value of the “good” score cannot be greater than β or less than 0. If it greater than 1, then the value is rounded to β where β is a predetermined value that can be set in any number of ways discussed above with regard to weighting values. In some embodiments, β can be equal to 0.5. In some embodiments, β can be equal to 1. In some embodiments, having a certain value of a “bad” score can have a negative effect on the “good” score. This means that having too many controversial nutrients may trump the health value of a food item that is provided by the non-controversial nutrients and vitamins. If that is the case, in some embodiments, the good score can be reduced by a predetermined fraction or a percentage. Thus, for example, if (saturated fat nutrient score+trans fat nutrient score+cholesterol nutrient score) is greater than 15, there can be a 50% penalty on the “good” score.

The method proceeds to determine a combined nutrient/vitamin score based on the “good” and “bad” scores, as follows:

Nutrient/Vitamin=((70+(100*Good Score))−(Bad Score*100))[0,λ] (6)
where λ is some predetermined value. In some embodiments, λ=100.

In the above equation, (g) is a maximum weight of the “good” score; a weight function is a mathematical device that gives some elements more “weight” or influence on the result than other elements in the same set. In some embodiments, the maximum weight (g) can be equal to 100 if the ingredient score is 0. An ingredient score of 0 represents a food item that has no controversial ingredients. Hence, bad score would also equal to 0. In some embodiments, the maximum weight (g) can have a specific predetermined value assigned to it if the ingredient score is greater than 0. In an embodiment when the ingredient score is greater than 0, (g) equals to 10. Further, the combined nutrient/vitamin score cannot be less than 0 or more than 50. If it is more than 50, then it is rounded off to 50. In some embodiments, if a product has too many “bad” nutrients (e.g., saturated fat), the “good” score value may be limited to a predetermined value. For example, such predetermined value can be equal to 40. When a product has too many “bad” nutrients, its nutrient score is greater than or equal to the total weight value. For example, a product having a saturated fat score of 10 or more would be considered as having too many “bad” nutrients.

Because controversial ingredients sometimes negatively affect the health value of a food item and thus may have a potentially adverse effect on the user's health after consuming food items containing such ingredients, the eventual health score of a food item is offset by a penalty for having such controversial ingredients. The penalty is calculated as follows:

Controversial ingredient penalty=1−ingredient score (7)
where the ingredient score is calculated using equation (3). In some embodiments, the penalty value cannot be negative and hence, if the ingredient score is greater than 1, then the penalty value is equal to 0.

Finally, the health value or score of a food item is calculated using the following relationship:

Health Score=Nutrient/Vitamin score*Controversial ingredient penalty [0,ε] (8)
where ε is a predetermined value and the health score cannot be less than 0 or more than ε. If the score is more than ε, then it is rounded off to ε. In some embodiments, ε=100. The following example illustrates the above calculation.

### EXAMPLE 1

Assuming a user is about to consume Barnum's Animals® Crackers [7 oz] manufactured by Kraft Foods, Inc., Northfield, Ill. This item can be obtained from a local supermarket, convenience store, or otherwise. The item has an appropriate labeling as required by the FDA. Using this labeling and information stored in the database, the following values are obtained:

TABLE 4
Nutrients in Barnum's Animals ® Crackers.

| | Nutrient's | | |
|---|---|---|---|
| | Approximate | Nutrient | Nutrient Score |
| Item's Nutrient | Weight in Item | Weighting | (Equation (1)) |
| Saturated Fat | .3842 | 20 | 7.69 |
| Trans Fat | 0 | 20 | 0 |
| Cholesterol | 0 | 20 | 0 |
| Sodium | .9616 | 5 | 4.81 |
| Sugar | 2.6924 | 10 | 10 |
| Protein | .5129 | 17 | 8.72 |
| Dietary Fiber | 0 | 16 | 0 |
| Potassium | 0 | 7 | 0 |

Next, a vitamin score is calculated for Barnum's Animals® Crackers [7 oz].

TABLE 5
Vitamin Score for Barnum's Animals ® Crackers [7 oz].

| Vitamin/Mineral | Percent of Vitamin |
|---|---|
| Vitamin A | 0 |
| Vitamin C | 0 |
| Calcium | 10 |
| Iron | 6 |
| Vitamin D | 0 |
| Vitamin E | 0 |
| Vitamin K | 0 |
| Thiamin | 0 |
| Riboflavin | 0 |
| Niacin | 0 |
| Vitamin B6 | 0 |
| Folate | 0 |
| Vitamin B12 | 0 |
| Biotin | 0 |
| Pantothenic acid | 0 |
| Phosphorus | 0 |
| Iodine | 0 |
| Magnesium | 0 |
| Zinc | 0 |
| Selenium | 0 |
| Copper | 0 |
| Manganese | 0 |
| Chromium | 0 |
| Molybdenum | 0 |
| Chloride | 0 |
| Vitamin Score | 0.8 |
| (Equation (2)) | |

The total number of ingredients in Barnum's Animals® Crackers [7 oz] is equal to 17 and the number of controversial ingredients is equal to 3. The ingredient score is calculated using equation (3) and is equal to 0.29. There is one hydrogenated ingredient, thus, the penalty is calculated as equal to 5/17.

Based on these values, the “bad” score, the “good” score, the maximum weight (g), the controversial ingredient penalty, and the health score are calculated. The values are calculated using equations (4)-(8) discussed above and are illustrated in Table 6 below:

TABLE 6
Health score of Barnum's Animals ® Crackers.

| Barnum's Animals ® Crackers | SCORE |
|---|---|
| “bad” score | 22.5 |
| “good” score | 9.52 |
| maximum “good” score | 10 |
| controversial ingredient penalty | 1-0.29 |
| health score | 40 |

Since, controversial ingredients are present in Barnum's Animals® Crackers, the good score maxes out at 10. In this case, the natural “good” score is applied since it is less than 10.

The higher the score the healthier the food item that is being consumed and/or it may have a more positive health-wise effect on the user that is consuming the food item. Lower health score may have a more negative effect on the quality of the food item and as such, may have an adverse effect on the user's health after consuming such food item.

As can be understood by one skilled in the art, the values of α, β, λ, δ, and ε discussed above can be predetermined values (such as those indicated above). The determination of these values can be based on various experimentations, calculations, opinions of nutritional or other experts, or in any other manner. In some embodiments, these values can be generated by a computing device. Further, these values can depend on various factors and parameters about a particular food item and/or steps and/or method for determining a health value of a food item.

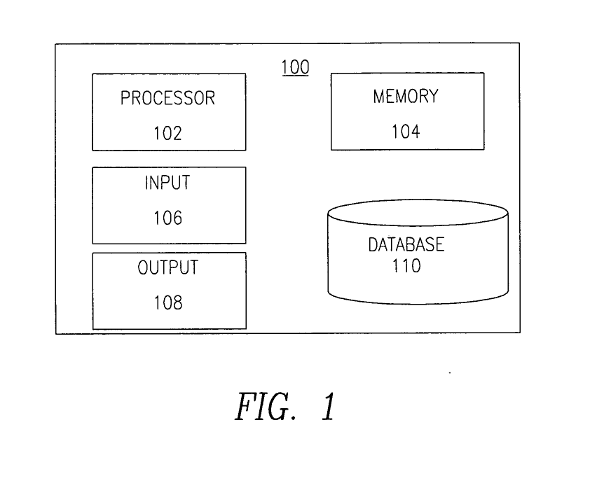

FIG. 1 illustrates an exemplary computer-implemented system 100 for determining a nutritional health value or a health score of a food item using the methodology discussed above, according to some embodiments of the present invention. The food item can be any food item (e.g., cereal, milk, oatmeal, cheese, butter, meat, etc.). The system 100 can include a processor 102 configured to execute various instructions, a memory 104, an input device 106, and an output device 108. The system can also include database 110 that is configured to store information about food items, their nutrient content, vitamin content, ingredient content, as well as any other information that may be pertinent in calculating the health score, according to the present invention.

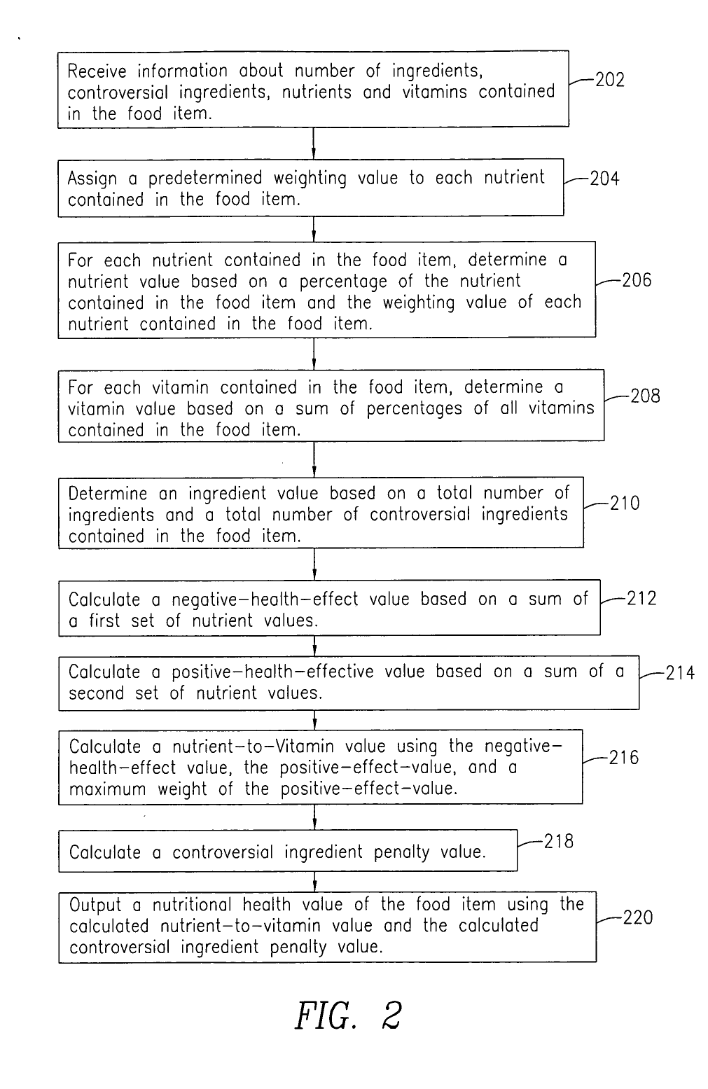

FIG. 2 is a flowchart that illustrates an exemplary computer-implemented method 200 for determining a nutritional health value or a health score of a food item described above. The method begins with step 202. In step 202, the processing begins with receiving information about number of ingredients, controversial ingredients, nutrients and vitamins contained in the food item. In step 204, a predetermined weighting value is assigned to each nutrient contained in the food item. Then, in step 206, for each nutrient contained in the food item, determining a nutrient value based on a percentage of the nutrient contained in the food item and the weighting value of each nutrient contained in the food item. In step 208, for each vitamin contained in the food item, determining a vitamin value based on a sum of percentages of all vitamins contained in the food item. The processing then proceeds to step 210. In step 210, an ingredient value is determined based on a total number of ingredients and a total number of controversial ingredients contained in the food item. In step 212-218, the following are calculated:
an negative-health-effect value based on a sum of a first set of nutrient values, wherein the first set of nutrient values is configured to have a negative health effect on the quality of the food item;
a positive-health-effect value based on a sum of a second set of nutrient values, wherein the second set of nutrient values is configured to have a positive health effect on the quality of the food item;
a nutrient-to-vitamin value using the calculated negative-health-effect value, the calculated positive-effect-value, and a maximum weight of the calculated positive-effect-value;
a controversial ingredient penalty value;

The processing proceeds to step 220, where a nutritional health value of the food item is generated using the calculated nutrient-to-vitamin value and the calculated controversial ingredient penalty value. In some embodiments, the system shown in FIG. 1 is configured to perform steps 202-220 of the method 200 in order to calculate the nutritional health value of the food item. In some embodiments, the present invention relates to a computer program product stored on a computer-readable medium, for use with a computer configured to determine a nutritional health value of a food item, the computer program product including computer-readable instructions for causing the computer to execute method 200.

Example embodiments of the methods and components of the present invention have been described herein. As noted elsewhere, these example embodiments have been described for illustrative purposes only, and are not limiting. Other embodiments are possible and are covered by the invention. Such embodiments will be apparent to persons skilled in the relevant art(s) based on the teachings contained herein. Thus, the breadth and scope of the present invention should not be limited by any of the above-described exemplary embodiments, but should be defined only in accordance with the following claims and their equivalents.

What is claimed:

1. A computer-implemented method for determining a nutritional health value of a food item, comprising the steps of:
receiving information about number of ingredients, controversial ingredients, nutrients and vitamins contained in the food item;
assigning a predetermined weighting value to each nutrient contained in the food item;
for each nutrient contained in the food item, determining a nutrient value based on a percentage of the nutrient contained in the food item and the weighting value of each nutrient contained in the food item;
for each vitamin contained in the food item, determining a vitamin value based on a sum of percentages of all vitamins contained in the food item;
determining an ingredient value based on a total number of ingredients and a total number of controversial ingredients contained in the food item;
calculating
an negative-health-effect value based on a sum of a first set of nutrient values, wherein the first set of nutrient values is configured to have a negative health effect on the quality of the food item;
a positive-health-effect value based on a sum of a second set of nutrient values, wherein the second set of nutrient values is configured to have a positive health effect on the quality of the food item;
a nutrient-to-vitamin value using the calculated negative-health-effect value, the calculated positive-effect-value, and a maximum weight of the calculated positive-effect-value;
a controversial ingredient penalty value;
generating a nutritional health value of the food item using the calculated nutrient-to-vitamin value and the calculated controversial ingredient penalty value.

2. The method according to claim 1, wherein the nutrient value is determined as follows
nutrient value=((p/r)[0,δ])*w,
wherein p is a percent of the nutrient in the food item; r is a percent recommended daily intake of the nutrient; w is the weighting of the nutrient; [0, δ] indicates that the value of (p/r) is greater than 0 and less than δ, wherein δ is a predetermined value.

3. The method according to claim 1, wherein the vitamin value is determined as follows
vitamin value=SUM(v)*xᵥ
wherein v is a percent of each vitamin in the food item; SUM indicates a sum of all vitamins in the food item; and xᵥ is a weighting value of each vitamin in the food item.

4. The method according to claim 1, wherein the ingredient value is determined as follows
ingredient value=c/a
wherein c is the number of controversial ingredients and a is the total number of ingredients in the food item.

5. The method according to claim 4, wherein said step of receiving further comprises
obtaining the number of ingredients, the number of controversial ingredients, the nutrients and the vitamins information from a database.

6. The method according to claim 1, wherein the negative-health-effect value is determined as follows:
negative-health-effect value=(sum of nutrient values for each nutrient in the first set of nutrients)/100 [0, α]
wherein the negative-health-effect value cannot be greater than α or less than 0, wherein α is a predetermined value.

7. The method according to claim 6, wherein the first set of nutrients includes saturated fat, trans fat, cholesterol, sodium, and sugar.

8. The method according to claim 1, wherein the positive-health-effect value is determined as follows:
positive-health-effect value=(sum of nutrient values for each nutrient in the second set of nutrients and vitamin value)/100 [0, β]
wherein the positive-health-effect value cannot be greater than β or less than 0, wherein β is a predetermined value.

9. The method according to claim 8, wherein the second set of nutrients includes protein, dietary fiber, and potassium.

10. The method according to claim 1, wherein the nutrient-to-vitamin value is determined as follows
nutrient-to-vitamin value=(70+(100*positive-health-effect value)−(100*negative-health-effect value))[0, λ]
wherein (g) is the maximum weight of the positive-health-effect value; the nutrient-to-vitamin value cannot be less than 0 or more than λ, where λ is a predetermined value.

11. The method according to claim 1, wherein the nutritional health value of the food item is generated as follows
nutritional health value=nutrient-to-vitamin value*Controversial ingredient penalty value [0, ε]
wherein the health score cannot be less than 0 or more than ε, where ε is a predetermined value; controversial ingredient penalty value is determined as follows
controversial ingredient penalty value=1−ingredient value.

12. A computer-implemented system for determining a nutritional health value of a food item, comprising:
a memory;
a processor configured to
receive information about number of ingredients, controversial ingredients, nutrients and vitamins contained in the food item;
assign a predetermined weighting value to each nutrient contained in the food item;
for each nutrient contained in the food item, determine a nutrient value based on a percentage of the nutrient contained in the food item and the weighting value of each nutrient contained in the food item;
for each vitamin contained in the food item, determine a vitamin value based on a sum of percentages of all vitamins contained in the food item;
determine an ingredient value based on a total number of ingredients and a total number of controversial ingredients contained in the food item;
calculate
a negative-health-effect value based on a sum of a first set of nutrient values, wherein the first set of nutrient values is configured to have a negative health effect on the quality of the food item;
a positive-health-effect value based on a sum of a second set of nutrient values, wherein the second set of nutrient values is configured to have a positive health effect on the quality of the food item;
a nutrient-to-vitamin value using the calculated negative-health-effect value, the calculated positive-effect-value, and a maximum weight of the calculated positive-effect-value;
a controversial ingredient penalty value;
output a nutritional health value of the food item using the calculated nutrient-to-vitamin value and the calculated controversial ingredient penalty value.

13. The system according to claim 12, wherein the nutrient value is determined by the processor as follows
nutrient value=((p/r)[0, δ])*w,
wherein p is a percent of the nutrient in the food item; r is a percent recommended daily intake of the nutrient; w is the weighting of the nutrient; [0, δ] indicates that the value of (p/r) is greater than 0 and less than δ, wherein δ is a predetermined value.

14. The system according to claim 12, wherein the vitamin value is determined by the processor as follows
vitamin value=SUM(v)*xᵥ
wherein v is a percent of each vitamin in the food item; SUM indicates a sum of all vitamins in the food item; and xᵥ is a weighting value of each vitamin in the food item.

15. The system according to claim 12, wherein the ingredient value is determined by the processor as follows
ingredient value=c/a
wherein c is the number of controversial ingredients and a is the total number of ingredients in the food item.

16. The system according to claim 15, wherein the processor obtains the number of ingredients, the number of controversial ingredients, the nutrients and the vitamins information from a database.

17. The system according to claim 12, wherein the negative-health-effect value is determined by the processor as follows:
negative-health-effect value=(sum of nutrient values for each nutrient in the first set of nutrients)/100 [0, α]
wherein the negative-health-effect value cannot be greater than α or less than 0, wherein α is a predetermined value.

18. The system according to claim 17, wherein the first set of nutrients includes saturated fat, trans fat, cholesterol, sodium, and sugar.

19. The system according to claim 12, wherein the positive-health-effect value is determined by the processor as follows:
positive-health-effect value=(sum of nutrient values for each nutrient in the second set of nutrients and vitamin value)/100 [0, β]
wherein the positive-health-effect value cannot be greater than β or less than 0, wherein β is a predetermined value.

20. The system according to claim 19, wherein the second set of nutrients includes protein, dietary fiber, and potassium.

21. The system according to claim 12, wherein the nutrient-to-vitamin value is determined by the processor as follows
nutrient-to-vitamin value=(70+(100*positive-health-effect value)+(100*negative-health-effect value)) [0, λ]
wherein (g) is the maximum weight of the positive-health-effect value; the nutrient-to-vitamin value cannot be less than 0 or more than λ, where λ is a predetermined value.

22. The system according to claim 12, wherein the nutritional health value of the food item is generated by the processor as follows
nutritional health value=nutrient-to-vitamin value*Controversial ingredient penalty value [0, ε]
wherein the health score cannot be less than 0 or more than ε, where ε is a predetermined value; controversial ingredient penalty value is determined as follows
controversial ingredient penalty value=1−ingredient value.

23. A computer program product stored on a computer-readable medium, for use with a computer configured to determine a nutritional health value of a food item, the computer program product comprising computer-readable instructions for causing the computer to:
receive information about number of ingredients, controversial ingredients, nutrients and vitamins contained in the food item;
assign a predetermined weighting value to each nutrient contained in the food item;
for each nutrient contained in the food item, determine a nutrient value based on a percentage of the nutrient contained in the food item and the weighting value of each nutrient contained in the food item;
for each vitamin contained in the food item, determine a vitamin value based on a sum of percentages of all vitamins contained in the food item;
determine an ingredient value based on a total number of ingredients and a total number of controversial ingredients contained in the food item;
calculate
an negative-health-effect value based on a sum of a first set of nutrient values, wherein the first set of nutrient values is configured to have a negative health effect on the quality of the food item;
a positive-health-effect value based on a sum of a second set of nutrient values, wherein the second set of nutrient values is configured to have a positive health effect on the quality of the food item;
a nutrient-to-vitamin value using the calculated negative-health-effect value, the calculated positive-effect-value, and a maximum weight of the calculated positive-effect-value;
a controversial ingredient penalty value;
generate a nutritional health value of the food item using the calculated nutrient-to-vitamin value and the calculated controversial ingredient penalty value.

24. The computer-program product according to claim 23, further comprising computer-readable instructions for causing the computer to determine the nutrient value as follows
nutrient value=((p/r)[0, δ])*w,
wherein p is a percent of the nutrient in the food item; r is a percent recommended daily intake of the nutrient; w is the weighting of the nutrient; [0, δ] indicates that the value of (p/r) is greater than 0 and less than δ, wherein δ is a predetermined value.

25. The computer-program product according to claim 23, further comprising computer-readable instructions for causing the computer to determine the vitamin value as follows
vitamin value=SUM(v)*xᵥ
wherein v is a percent of each vitamin in the food item; SUM indicates a sum of all vitamins in the food item; and xᵥ is a weighting value of each vitamin in the food item.

26. The computer-program product according to claim 23, further comprising computer-readable instructions for causing the computer to determine the ingredient value as follows
ingredient value=c/a
wherein c is the number of controversial ingredients and a is the total number of ingredients in the food item.

27. The computer-program product according to claim 26, further comprising computer-readable instructions for causing the computer to obtain the number of ingredients, the number of controversial ingredients, the nutrients and the vitamins information from a database.

28. The computer-program product according to claim 23, further comprising computer-readable instructions for causing the computer to determine the negative-health-effect value as follows:
negative-health-effect value=(sum of nutrient values for each nutrient in the first set of nutrients)/100 [0, α]
wherein the negative-health-effect value cannot be greater than α or less than 0, wherein α is a predetermined value.

29. The computer-program product according to claim 28, wherein the first set of nutrients includes saturated fat, trans fat, cholesterol, sodium, and sugar.

30. The computer-program product according to claim 23, further comprising computer-readable instructions for causing the computer to determine the positive-health-effect value as follows:
positive-health-effect value=(sum of nutrient values for each nutrient in the second set of nutrients and vitamin value)/100 [0, β]
wherein the positive-health-effect value cannot be greater than β or less than 0, wherein β is a predetermined value.

31. The computer-program product according to claim 30, wherein the second set of nutrients includes protein, dietary fiber, and potassium.

32. The computer-program product according to claim 23, further comprising computer-readable instructions for causing the computer to determine the nutrient-to-vitamin value as follows
nutrient-to-vitamin value=(70−(100*positive-health-effect value)+(100*negative-health-effect value))[0, λ]
wherein (g) is the maximum weight of the positive-health-effect value; the nutrient-to-vitamin value cannot be less than 0 or more than λ, where λ is a predetermined value.

33. The computer-program product according to claim 23, further comprising computer-readable instructions for causing the computer to generate the nutritional health value of the food item as follows
nutritional health value=nutrient-to-vitamin value*Controversial ingredient penalty value [0, ε]
wherein the health score cannot be less than 0 or more than ε, where ε is a predetermined value; controversial ingredient penalty value is determined as follows
controversial ingredient penalty value=1−ingredient value.
